(19) United States
(12) Patent Application Publication
(10) Pub. No.: US 2024/0182357 A1
(43) Pub. Date: Jun. 6, 2024

(54) GLASS AND CERAMIC STRUCTURES, AND METHODS FOR FABRICATION AND USE THEREOF

(71) Applicant: UNIVERSITY OF MARYLAND, COLLEGE PARK, College Park, MD (US)

(72) Inventors: Liangbing HU, Rockville, MD (US); Xinpeng ZHAO, Berwyn Heights, MD (US)

(21) Appl. No.: 18/529,626

(22) Filed: Dec. 5, 2023

Related U.S. Application Data
(60) Provisional application No. 63/430,330, filed on Dec. 5, 2022.

(51) Int. Cl. C03C 17/25; C03C 3/06; C03C 4/02

(52) U.S. Cl. CPC C03C 17/25; C03C 3/06; C03C 4/02; C03C 2201/40; C03C 2203/50; C03C 2204/00; C03C 2218/11; C03C 2218/32

(57) ABSTRACT

A structure can comprise a substrate and a composite coating. The composite coating can be formed over a surface of the substrate. The composite coating can include one or more nanoparticles within an oxide matrix. The nanoparticles can be formed of a temperature-dependent Mott insulator having a phase transition temperature. At a temperature below the phase transition temperature, the composite coating can transmit light in a first wavelength range, and at a temperature above the phase transition temperature, the composite coating can block light in the first wavelength range. For example, the structure can be used as a smart 10 window to help regulate heating of building interiors due to solar radiation. The composite coating can be formed via a short-duration, high-temperature heating pulse, for example, at least 1500 K for less than 60 seconds.

### CROSS-REFERENCE TO RELATED APPLICATION(S)

The present application claims the benefit of U.S. Provisional Application No. 63/430,330, filed Dec. 5, 2022, entitled “Energy-Efficient Glass and Ceramic Structures, and Methods for Fabrication and Use Thereof,” which is hereby incorporated by reference herein in its entirety.

### STATEMENT REGARDING PRIOR DISCLOSURE

Pursuant to 35 U.S.C. § 102(b)(1)(A), “Rapid Pressureless Sintering of Glasses” was published by the instant inventors in volume 18, issue 17 of the journal Small on Apr. 27, 2022 (published online on Mar. 30, 2022).

### FIELD

The present disclosure relates generally to glass and ceramic structures, and more particularly, to glass/ceramic structures formed by short-duration, high-temperature sintering.

### BACKGROUND

Glasses, such as fused silica (SiO₂) glasses, are widely used in the fields of optics, electronics, and chemical manufacturing for their physicochemical properties, such as high transparency, low thermal expansion coefficient, long-term chemical durability, good electrical insulation, and high hardness. Due to the high melting point of pure silica (e.g., ˜2000K), silica glasses have historically been manufactured by melting natural crystalline quartz or silicon compound precursors at high temperatures of 2273-2573 K. However, such fabrication methods can require large amounts of energy to generate the high temperatures necessary to cause melting. Conventional solid-state sintering techniques can reduce the processing temperature but generally require treatment times on the order of hours in order to obtain dense silica glasses. For example, silica glass with a transmittance of ˜83% was synthesized by gel-casting and sintering at a temperature of only 1373 K, but required as long as 3 hours to perform sintering.

Other sintering techniques for synthesizing silica glass have also proved to be deficient. Spark plasma sintering (SPS), also known as a field-assisted sintering technology (FAST), can obtain dense glasses with a short sintering time (e.g., 2-10 minutes) and at sintering temperatures below the melting point for pure silica (e.g., 1073-1883 K). However, SPS requires specialized equipment to simultaneously provide mechanical pressure (e.g., 6-100 MPa) and pulsed direct current, which can be costly for many commercial products. Flash sintering (FS) requires a high electric field (e.g., up to 3000 V/cm) due to the large electrical resistivity of the glass powder compact. In addition, although the densification of the glass powders takes place within a few seconds during the flash sintering process, an extended duration preheating of the powders in a conventional furnace is typically needed prior to the flash sintering, which can substantially increase overall processing time. Laser sintering can quickly heat silica precursors. However, the sintering rate is limited by the output power, scanning speed (e.g., 1 mm/s), and spot size (e.g., a diameter of ˜1 mm). In addition, the laser-sintered structures can retain a porous configuration that prevents high transparency.

Glasses area also widely used in buildings, including windows, curtain walls, and transparent roofs, due to their high solar transparency (˜ 90%), long-term chemical durability, and high mechanical strength. Sunlight (up to 1000 W/m2) that enters buildings through glasses can induce overheating in hot seasons, which can significantly increase cooling loads (and corresponding greenhouse gas emissions). Various functional coatings (e.g., anti-reflective, low-emissivity, electrochromic, thermochromic, photochromic) have been employed to control solar transmission through glass in order to improve the building energy efficiency. However, such coatings typically rely on deposition techniques (e.g., vacuum thermal evaporation, electron beam or laser beam evaporation, sputtering, chemical vapor deposition, atomic layer deposition) that require complex setups and/or vacuum environments. In addition, the coating speed is in the range of several nanometers per second, making the coating process time-consuming. Moreover, the above techniques are generally applicable to the fabrication of continuous films rather than particle-based coating. While other coating techniques, such as spray coating and spin coating, can fabricate particle-based porous coatings on glass (e.g., at a speed of several to dozens of microns per second), the weak interparticle and coating-substrate bonding strengths can result in a coating layer that is easily removed (e.g., by peeling), thus limiting their usage.

Embodiments of the disclosed subject matter may address one or more of the above-noted problems and disadvantages, among other things.

### SUMMARY

Embodiments of the disclosed subject matter provide novel glass and ceramic structures formed, for example, by exposing a precursor structure to a short-duration (e.g., less than 60 seconds), high-temperature (e.g., at least 1500 K) heating pulse. In some embodiments, a composite coating can be formed on a substrate (e.g., silica glass) to imbue the substrate with one or more functional properties, for example, to provide temperature-dependent transmittance with respect to solar radiation. The composite coating can have nanoparticles embedded within an oxide matrix (e.g., ceramic or glass) and can be formed, for example, by sintering a powder precursor. In some embodiments, a glass can be formed by cold isostatic pressing (CIP) a powder to form a precursor structure (e.g., pellet), and then sintering the precursor structure by exposing to the short-duration, high-temperature heating pulse. In some embodiments, the precursor structure may include an additive (e.g., dye or dopant, such as a metal salt or metal oxide) or nanoparticles (e.g., plasmonic nanoparticles), for example, mixed with the powder prior to CIP or infiltrated via solution into the precursor structure after CIP.

In one or more embodiments, a structure can comprise a substrate and a composite coating. The composite coating can be formed over a surface of the substrate. The composite coating can comprise one or more nanoparticles within an oxide matrix. The one or more nanoparticles can comprise a temperature-dependent Mott insulator having a phase transition temperature. At a temperature below the phase transition temperature, the composite coating can transmit light in a first wavelength range. At a temperature above the phase transition temperature, the composite coating can block (e.g., reflect and/or absorb) light in the first wavelength range.

In one or more embodiments, a method can comprise forming a precursor coating by dispensing a slurry over a surface of a substrate. The slurry can comprise a precursor powder and one or more nanoparticles in a solution. The one or more nanoparticles can comprise a temperature-dependent Mott insulator having a phase transition temperature. The method can further comprise, after forming the precursor coating, subjecting the precursor coating to a high temperature heating pulse. The high temperature heating pulse can comprise exposure to a temperature of at least 1500 K for a duration of less than 60 seconds. The high temperature heating pulse can be effective to convert (e.g., sinter) the precursor coating into a composite coating. The composite coating can have a porosity and/or density greater than the precursor coating. The composite coating can comprise an oxide matrix formed from the precursor powder and the one or more nanoparticles within the oxide matrix. The method can also comprise using the substrate with composite coating as a smart window. For example, the composite coating can transmit light in a first wavelength range when at a temperature below the phase transition temperature, and the composite coating can block (e.g., reflect and/or absorb) light in the first wavelength range when at a temperature above the phase transition temperature.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. Throughout the figures, like reference numerals denote like elements.

FIG. 1 is a simplified schematic diagram illustrating a fabrication process for forming a composite coating on a substrate, according to one or more embodiments of the disclosed subject matter.

FIGS. 2A-2B illustrate operational aspects of a smart window exposed to cold and hot temperatures, respectively, according to one or more embodiments of the disclosed subject matter.

FIG. 3 is a graph of transmittance versus wavelength for a fabricated smart window exposed to cold (20° C.) and hot (90° C.) temperatures.

FIG. 4A is a simplified schematic diagram illustrating conversion of pressed precursor pellet into a glass pellet via a high temperature heating pulse, according to one or more embodiments of the disclosed subject matter.

FIG. 4B shows images of a pellet before (left) and after (right) sintering via a high temperature heating pulse, according to one or more embodiments of the disclosed subject matter.

FIG. 4C is a graph comparing times for forming a dense glass material using different fabrication techniques.

FIG. 5A illustrates a temperature profile for a high temperature heating pulse to form a glass structure, according to one or more embodiments of the disclosed subject matter.

FIG. 5B shows images of a pellet at different times during a sintering stage of the high temperature heating pulse, according to one or more embodiments of the disclosed subject matter.

FIGS. 5C-5D illustrate microstructure details of the pellet in FIG. 5B at corresponding times during the sintering stage, according to one or more embodiments of the disclosed subject matter.

FIG. 6A is a graph of transmittance versus wavelength for a silica glass pellet before and after sintering via the high temperature heating pulse.

FIG. 6B are images of a silica glass pellet in contact with a grid background, before and after sintering via the high temperature heating pulse.

FIG. 6C are images of a silica glass pellet raised 3 cm above the grid background, before and after sintering via the high temperature heating pulse.

FIG. 6D is a simplified schematic diagram illustrating aspects of heat and light transmission through a glass pellet before and after sintering via the high temperature heating pulse.

FIG. 6E is a graph of thermal conductivity at room temperature for fused silica glass and a silica glass pellet before and after sintering via the high temperature heating pulse.

FIG. 7A shows cross-sectional scanning electron microscopy (SEM) images (top row) and optical images (middle row) of silica pellets sintered at ˜1600 K for sintering times of 4, 20, 50, and 80 seconds, as well as a graph of relative density and pore size versus sintering time at ˜1600 K.

FIG. 7B shows optical (left) and SEM (right) images of a silica pellet sintered at a ˜ 1300 K for 100 seconds.

FIG. 7C shows optical (left) and SEM (right) images of a silica pellet sintered at a ˜ 1750 K for 10 seconds.

FIG. 7D is a map of resulting characteristics of a sintered silica pellet based on sintering time and sintering temperature.

FIG. 8A is a simplified schematic diagram illustrating conversion of a doped precursor pellet into a glass pellet via a high temperature heating pulse, according to one or more embodiments of the disclosed subject matter.

FIG. 8B is a simplified schematic diagram illustrating a fabrication process for forming colored glass, according to one or more embodiments of the disclosed subject matter.

FIG. 8C shows optical images of CoCl₂-doped glass, FeCl₃-doped glass, CuCl₂-doped glass, and undoped glass formed via a high temperature heating pulse.

FIG. 9A is a simplified schematic diagram illustrating operational aspects of an insulating glass with plasmonic nanoparticles formed via a high temperature heating pulse.

FIG. 9B is a simplified schematic diagram illustrating formation via a high temperature heating of an insulating glass with plasmonic nanoparticles.

FIG. 9C is a graph of in-line transmission versus wavelength for insulating glass (with 3 wt % ITO) and pure silica glass.

### DETAILED DESCRIPTION

### General Considerations

For purposes of this description, certain aspects, advantages, and novel features of the embodiments of this disclosure are described herein. The disclosed methods and systems should not be construed as being limiting in any way. Instead, the present disclosure is directed toward all novel and nonobvious features and aspects of the various disclosed embodiments, alone and in various combinations and sub-combinations with one another. The methods and systems are not limited to any specific aspect or feature or combination thereof, nor do the disclosed embodiments require that any one or more specific advantages be present, or problems be solved. The technologies from any embodiment or example can be combined with the technologies described in any one or more of the other embodiments or examples. In view of the many possible embodiments to which the principles of the disclosed technology may be applied, it should be recognized that the illustrated embodiments are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing embodiments from discussed prior art, the embodiment numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” right,” “front,” “back,” “rear,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### Overview of Terms

The following are provided to facilitate the description of various aspects of the disclosed subject matter and to guide those skilled in the art in the practice of the disclosed subject matter.

High-temperature Heating Pulse: Application of a temperature for a time period having a duration less than or equal to about 60 seconds. In some embodiments, the duration of the time period of heating pulse application is less than 30 seconds, for example, in a range of 3-10 seconds, inclusive. In some embodiments, the heating pulse may involve heating to the temperature at a ramp rate of at least 10¹ K/s (e.g., about 10² K/s or more) prior to the time period, and/or cooling from the temperature at a ramp rate of at least 10¹ K/s (e.g., about 10² K/s or more).

Heating pulse temperature: A peak or maximum temperature at a surface of one or more heating elements when energized (e.g., by application of a current pulse) and/or at a surface of a material being heated. In some embodiments, the heating pulse temperature is at least about 1000 K, for example, at least 1500 K. In some embodiments, the heating pulse temperature is in a range of about 1500 K to about 3000 K. In some embodiments, the heating pulse temperature is less than a melting temperature of the constituent materials, for example, in a range of 1500-1700 K, inclusive. In some embodiments, the heating pulse temperature is a maximum temperature experienced by a material being processed (e.g., a precursor pellet or a precursor coating on a substrate). In some embodiments, a temperature at a material being processed can match or substantially match (e.g., within 10%) the temperature of at least one heating element.

Powder: A plurality of particles, each having a maximum cross-sectional dimension (e.g., diameter when the particle is spherical) less than or equal to about 100 μm. In some embodiments, the powder, or a component thereof, can be considered a micropowder, e.g., having particle sizes in a range of 1-100 μm, for example, about 40-50 μm. Alternatively or additionally, the powder, or a component thereof, can be considered a nanopowder, e.g., having particles sizes in a range of 1 nm to 1 μm, for example, about 10-20 nm. In some embodiments, an identified particle size represents an average particle size for all particles (e.g., an average of the maximum cross-sectional dimensions). In some embodiments, the particle size can be measured according to one or more known standards, such as, but not limited to, ASTM B214-16 entitled “Standard Test Method for Sieve Analysis of Metal Powders,” ASTM B330-20 entitled “Standard Test Methods for Estimating Average Particle Size of Metal Powders and Related Compounds Using Air Permeability,” ASTM B822-20 entitled “Standard Test Method for Particle Size Distribution of Metal Powders and Related Compounds by Light Scattering,” and ASTM B922-20 entitled “Standard Test Method for Metal Powder Specific Surface Area by Physical Adsorption,” all of which are incorporated by reference herein.

Nanoparticle: A particle formed of one or more elements and having a maximum cross-sectional dimension (e.g., diameter when the particle is spherical) less than or equal to about 1 μm, for example, about 500 nm or less. In some embodiments, the nanoparticle has a maximum cross-sectional dimension of less than or equal to about 300 nm, for example, in a range of 10-100 nm, inclusive. In some embodiments, the nanoparticle comprises a Mott insulator or a plasmonic nanoparticle (e.g., an infrared plasmonic nanoparticle, such as indium tin oxide (ITO)).

Mott insulator: A material whose electrical conductivity is suppressed due to strong electron-electron interactions, despite a partially-filled electronic band. The Mott insulator can exhibit a metal-to-insulator transition in response to environmental factors, such as changes in temperature, pressure, and/or chemical composition. In some embodiments, the Mott insulator is temperature-dependent, for example, exhibiting different optical properties (e.g., light transmission, reflection, and/or absorption) based on whether its temperature is above or below a critical temperature (e.g., phase transition temperature). In some embodiments, the Mott insulator can comprise vanadium dioxide, nickel sulfide, nickel oxide, trigonal tantalum sulfide, or lithium cobalt oxide.

Cold Isostatic Pressing (CIP): Compacting a powder into a pellet by placing the powder in a flexible mold and then applying a hydrostatic pressure for a period of time to form the pellet (e.g., for further processing via sintering). In some embodiments, the applied pressure is less than 100 MPa, for example, about 40 MPa. In some embodiments, the period of time for the applied pressure is less than 60 seconds, for example, about 40 seconds.

Relative Density: The ratio of a measured density of a processed structure to the theoretical maximum density of the base material (e.g., glass or ceramic matrix) of the processed structure.

### INTRODUCTION

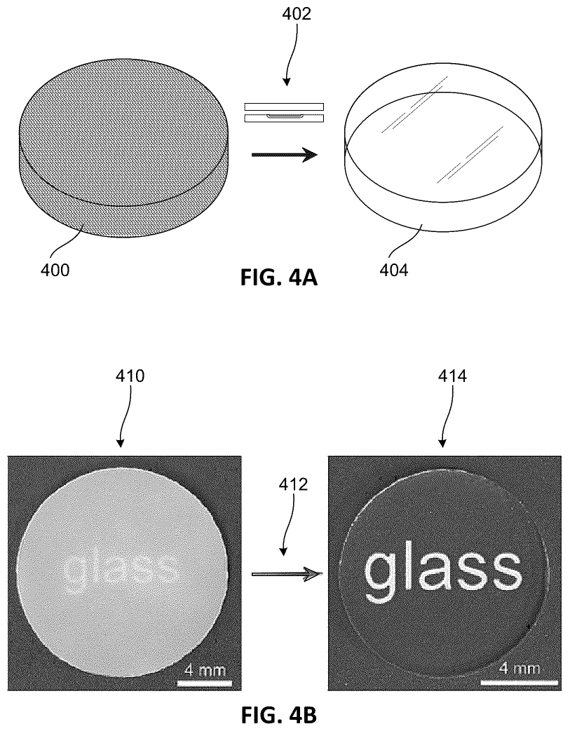

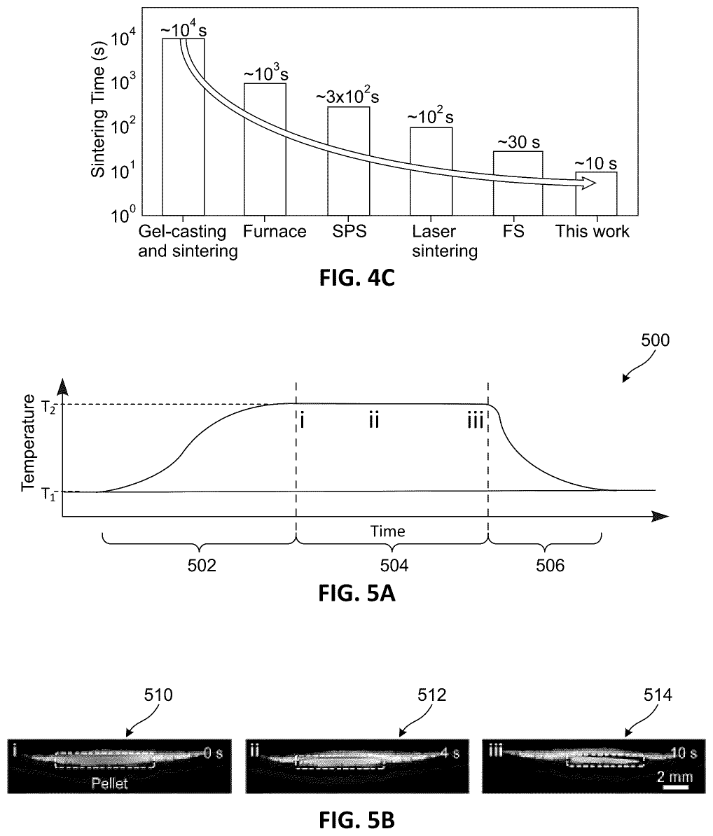

Disclosed herein are glass and/or ceramic structures, and methods for forming thereof by sintering. In some embodiments, a dense glass or ceramic pellet can be formed by rapid pressure-less sintering, for example, via a high temperature heating pulse. In some embodiments, a precursor powder (e.g., SiO₂) can be made into a pellet 400, for example, by cold isostatic pressing (CIP). In some embodiments, the pellet 400 can then be placed proximal to (e.g., in direct contact with or spaced by a small gap, for example, less than or equal to 1 cm) a heating element (e.g., a Joule-heated carbon heating element, such as carbon felt or film). In some embodiments, the heating element can quickly reach a high temperature (e.g., about 1600 K), thereby converting the pellet 400 into a sintered structure 404. In the illustrated example of FIG. 4A, a single pellet 400 is shown disposed between a pair of Joule-heating elements at sintering stage 402. However, in some embodiments, multiple pellets can be simultaneously heated, a single heating element or more than two heating elements can be used, and/or the pellet(s) can be disposed in contact with one or both heating elements, according to one or more contemplated embodiments. During the sintering process, the heating element can rapidly heat the pellet via thermal radiation and/or conduction.

Compared to other sintering methods, embodiments of the disclosed subject matter provide multiple advantages for glass fabrication. First, the large heating rate (e.g., ˜10² K/s) and high sintering temperature (e.g., ˜1600 K) of the heating element can dramatically decrease the sintering time from hours to seconds. Dense and highly transparent silica glass can be rapidly sintered via the disclosed method. Second, the lack of applied pressure and relatively low current (e.g., <50 A for a Joule heating element) can enable a simple fabrication setup compared to other electrification methods, such as SPS. Third, the disclosed technique can enable direct observation of the sintering process and can allow for manual adjustment of the sintering temperature and time parameters in real-time. In some embodiments, the disclosed pressure-less sintering technique can be used to sinter glass with various shapes, such as non-standard and/or non-planar geometries.

In the illustrated example of FIG. 4A, the sintering temperature is provided via a pair of Joule heating elements. Alternatively, in some embodiments, the short-duration, high-temperature heating can be provided by microwave heating, laser heating, electron beam heating, spark discharge heating, or any other heating mechanism capable of providing the sintering temperature, heating rate, and/or cooling rate. For example, the systems and methods for providing the high-temperature heating can be similar to those disclosed in International Publication No. WO 2020/236767, published Nov. 26, 2020 and entitled “High temperature sintering systems and methods,” and/or International Publication No. WO 2022/204494, published Sep. 29, 2022 and entitled “High temperature sintering furnace systems and methods,” each of which is incorporated herein by reference.

In the illustrated example of FIG. 4A, the duration of the sintering is controlled by application of electrical power (e.g., current) to the Joule heating elements. Alternatively or additionally, in some embodiments, the duration of the sintering is controlled by movement of the heating element with respect to the pellet (or portion thereof), movement of the pellet with respect to the heating element (or portion thereof), or both. For example, the sintering can be terminated by conveying the pellet out of a heating zone (e.g., by moving the pellet from between the Joule heating elements) and/or by de-activating, de-energizing, or otherwise terminating operation of the heating element. Alternatively or additionally, in some embodiments, cooling at the end of a heating period can be achieved using one or more passive cooling features (e.g., heat sinks thermally coupled to the heating element and/or sintered structures, etc.), one or more active cooling features (e.g., fluid flow directed at the sintered structures and/or the heater, fluid flow through a heat sink thermally coupled thereto, etc.), or any combination thereof.

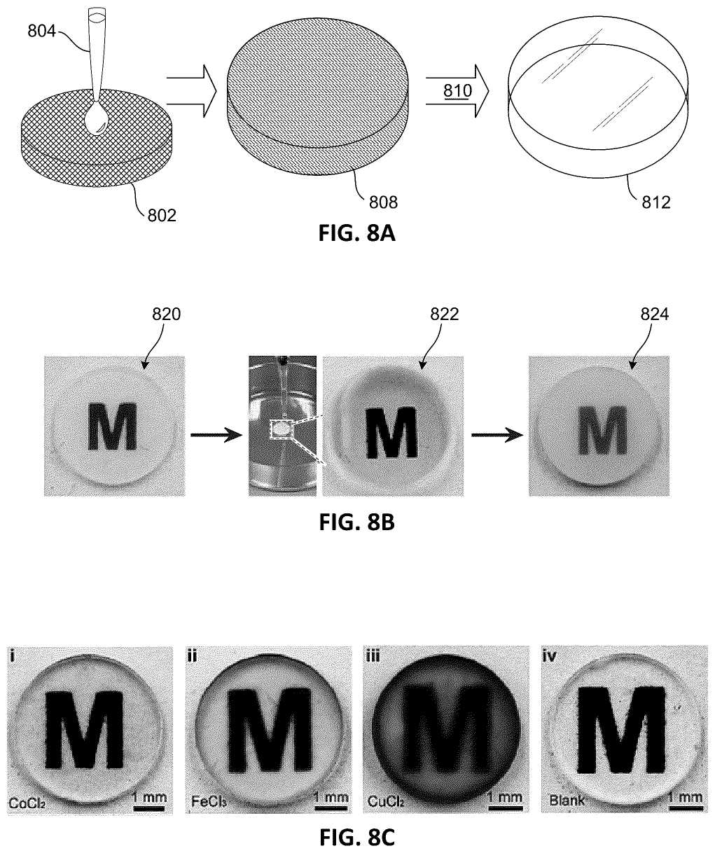

In some embodiments, the disclosed powder-based sintering technique can be used to fabricate a glass or ceramic composite, such as a functional glass (e.g., a colored glass for use as an optical filter, an insulating glass, or a glass with properties that vary based on temperature). In some embodiments, a colored glass can be formed by doping the precursor material with metal ions prior to sintering. Alternatively or additionally, an insulating glass can be formed by incorporating nanoparticles (e.g., plasmonic nanoparticles) into the precursor material prior to sintering FIG. 8A shows an approach for forming a functional glass, according to one or more embodiments of the disclosed subject matter. For example, a dye or colorant 804 (e.g., a solution of metal salt, such as FeCl₃) can be dispensed or coated onto a porous pressed pellet 802, such that the colorant 804 is absorbed, infused, or otherwise infiltrates into the pellet 802, thereby forming a composite precursor pellet 808. Subjecting the pellet 808 to a high temperature heating pulse 810 (e.g., via one or more Joule heating elements) can sinter the pellet, for example, to form functional glass 812 (e.g., colored glass). In some embodiments, the metal salts can be transformed into oxides in the glass during the sintering process.

In conventional methods for forming functional glass, a functional layer is coated on a previously-formed glass substrate. However, such coated functional layers may be unable to endure environmental interaction or manipulation (e.g., scratching or wiping), for example, with the coating readily delaminating (e.g., peeling off) at elevated temperatures due to thermal expansion mismatch between the coating and the glass substrate. Embodiments of the disclosed subject matter can avoid such issues by directly incorporating the functional material into the dense glass matrix. Alternatively or additionally, in some embodiments, the functional material (e.g., nanoparticles) can be incorporated into a coating (e.g., base matrix) formed on a substrate (e.g., glass). In some embodiments, the materials for the coating and the substrate can be selected to minimize differences between their respective coefficients of thermal expansion, for example, to avoid or at least reduce the risk of delamination. In some embodiments, the base matrix of the coating and the substrate are formed of a same material (e.g., silica).

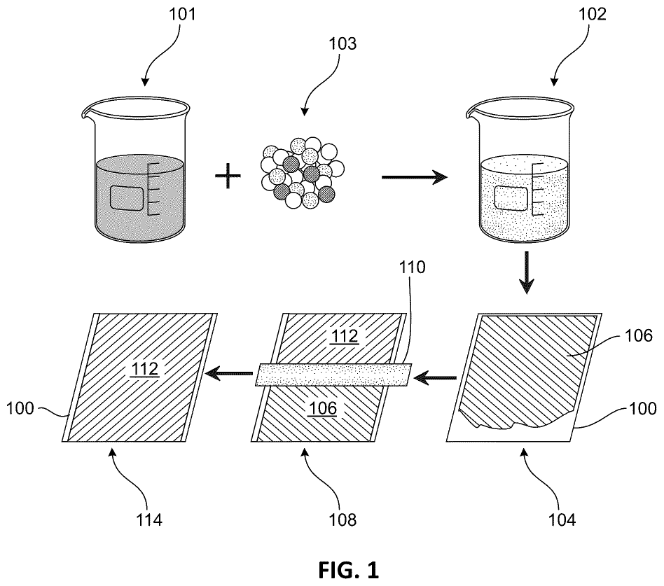

In some embodiments, the coating can be a ceramic layer formed (e.g., sintered) on the substrate using a short-duration, high-temperature heating pulse. For example, FIG. 1 illustrates fabrication of a nanoparticle-based ceramic coating 112 on or over a substrate 100 (e.g., glass). In the illustrated example, a liquid solution 101 (e.g., a solution having one or more nanoparticles therein, e.g., vanadium dioxide (VO₂) nanoparticles) and oxide powders 103 (e.g., ceramic powders, such as but not limited to silica or low-melting point glass) are uniformly mixed to obtain a slurry 102 with a desired concentration and/or viscosity. For example, the mixing can include ball milling, ultrasonic techniques, or any other mixing technique or combinations thereof. In some embodiments, the solution can include an organic liquid or an inorganic liquid, such as but not limited to water, acetone, ethanol, methanol, or 2-propanol. The slurry 102 can be provided on the substrate 100 and then dried (e.g., via ambient drying, air-flow drying, infrared drying, or any other drying technique) to form a substantially uniform coating layer 106 (e.g., 5-100 μm thick), as shown at stage 104 in FIG. 1. Any known technique can be used to form the coating layer 106 on the substrate. For example, in some embodiments, the slurry can be coated on the substrate 100 by spray coating, spin coating, or doctor blade method.

In some embodiments, the coating layer 106 can be subjected to a short-duration, high-temperature heating pulse 108, so as to convert (e.g., sinter) the coating 106 into a functional layer 112 on or over the substrate 100, as shown at stage 114. For example, a high-temperature heating element 110 (e.g., a Joule-heated carbon strip) can be used to heat the precursor film 106 by moving across the sample (e.g., spaced from the facing surface of the film 106 by a constant gap) such that each portion of the coating 106 is heated for a short duration (e.g., ≤ 60 seconds, such as about 3-10 seconds). In some embodiments, the substrate 100 can have a high transparency with respect to light and/or radiated heat, such that radiative heat (e.g., most of the radiative heat from the heat source 110) can be absorbed by the coating 106, thereby creating a localized high temperature zone at the coating. In some embodiments, the high temperature exposure can induce a transient sintering of the coating 106 and softening of the substrate 100, which can increase the interparticle connection and strongly bond the sintered coating 112 to the substrate.

In some embodiments, the heating element 110 provides a sintering temperature in a range of 1500-3000 K, inclusive (e.g., in a range of 1500-1700 K, such as about 1600 K for silica). Depending on the type of coating (e.g., material composition) and/or the type of heating element, the heating can be conducted in an open atmosphere (e.g., ambient air), restricted atmosphere (e.g., glovebox with argon, nitrogen, or other inert gas), vacuum atmosphere (e.g., vacuum chamber at a pressure less than 1 atm), or any other atmosphere.

In some embodiments, the nanoparticles in solution 101 and eventually incorporated into the composite coating 112 can exhibit Mott insulator properties, for example, VO₂ nanoparticles. For example, the process of FIG. 1 can directly embed the VO₂ nanoparticles into a ceramic matrix of the composite coating 112, which can enable a high optical performance and long lifetime due to its ultra-low gas permeability. For example, in some embodiments, VO₂ nanoparticles (e.g., having a size of 20-100 nm, inclusive) can be mixed with micro/nanoscale powders 103 of transparent ceramics such as, but not limited to, SiO₂, Al₂O₃, MgO, SiO₂—Al₂O₃—Na₂CO₃—CaO, SiO₂—Na₂O—ZnO—CaO, SiO₂—Al₂O₃—Na₂O—CaO—TiO₂, SiO₂—Na₂O—CaO, SiO₂—B₂O₃—BaO—ZnO, SiO₂—B₂O₃—Al₂O₃, SiO₂—B₂O₃—ZnO—Al₂O₃—K₂O, SiO₂—B₂O₃—ZnO—Li₂O, SiO₂—B₂O₃—ZnO—K₂O, PbO—B₂O₃—SiO₂, PbO—B₂O₃—SiO₂—ZnO, BizO₃—H₃BO₃—ZnO, Sb₂O₃—PbO—B₂O₃, Bi₂O₃—B₂O₃—ZnO—Sb₂O₅, Sb₂O₃—B₂O₃—ZnO—K₂O, ZnO—B₂O₃—BaO—Al₂O₃, P₂O₅—ZnO—Na₂O—Li₂O—BaO, P₂O₅—ZnO—Bi₂O₃, P₂O₅—ZnO—BaO—Na₂O, TeO₂—ZnO, TeO₂—Na₂O—ZnO—B₂O₃, TeO₂—ZnO—Na₂O—Al₂O₃, TeO₂—B₂O₃—ZnO—Na₂O—Al₂O₃, TeO₂—B₂O₃—Sb₂O₃—ZnO—Na₂O, TeO₂—Sb₂O₃—LizO—ZnO, SnO—SnF₂—P₂O₅ in a liquid solution. In some embodiments, a precursor slurry can be deposited, for example, via a spray coating technique, to achieve a thickness within a range of 5-100 μm, inclusive (e.g., ˜10 μm). The resulting precursor film can be rapidly sintered in an air atmosphere by moving a Joule-heated carbon strip 110 (e.g., at a temperature of ˜2000 K) across the sample with a duration of 3 seconds. In some embodiments, the concentration of nanoparticles in the sintered structure (e.g., ceramic coating) is less than or equal to ˜0.1 vol % (e.g., ˜0.01 vol %).

In one or more embodiments of the disclosed subject matter, a rapid and facile approach for sintering glass and/or ceramic materials is provided. The disclosed techniques can address the limitations of current sintering methods, such as long sintering times and complex manufacturing setups. The pressure-less sintering setup (e.g., employing one or more Joule heating elements, such as a carbon heater) features a simple configuration. For example, the Joule heating element can operate with a relatively low current of <50 A (much lower compared to that of the SPS technique which is up to thousands of amperes). The disclosed techniques can simplify the thermal treatment process by utilizing a large heating rate (e.g., ˜10² K/s) to achieve a short sintering time, for example, reducing the sintering time by 1-3 orders of magnitude as compared to previous methods. In some embodiments, the pressure-less sintering method can be integrated with a roll-to-roll process to realize continuous and scalable glass and/or ceramic manufacturing. Alternatively or additionally, the pressure-less sintering method can be employed in the discovery of new glass and/or ceramic materials, for example, for applications in advanced optics, optoelectronics, or energy-efficient buildings.

### Smart Window Examples

In some embodiments, sintered ceramic coatings on a substrate (e.g., optically transparent material, such as silica glass) can be used as a smart window, for example, to adjust transmission characteristics with respect to solar radiation or other electromagnetic radiation. For example, a smart window with high thermal resistance and dynamically adjustable transmission characteristics (e.g., a thermochromic film that changes transmittance based on temperature) can help reduce energy usage (e.g., by reducing the energy required to maintain a comfortable temperature within a building). For example, thermochromic smart windows can reduce energy demands for heating/cooling by 5-84%, as compared to static glass, depending on glazing types and climate conditions.

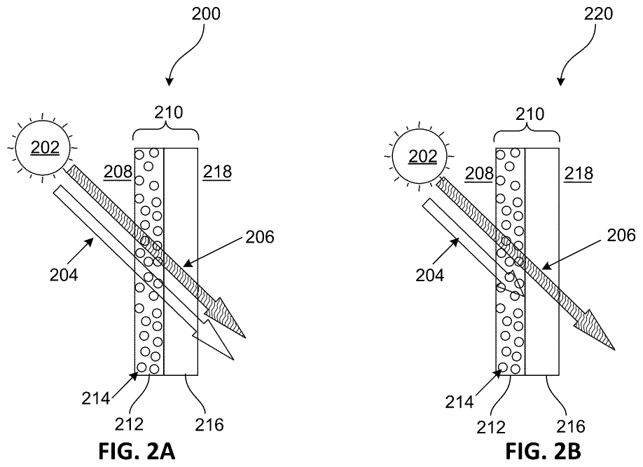

In some embodiments, the ceramic coating can comprise VO₂ (or other Mott insulator), which can dynamically change solar transmittance based on changes in the ambient or exposed temperature. For example, during cold exposure 200 (e.g., winter season), the ambient temperature in the environment 208 can be lower than a phase transition temperature of nanoparticles 214 (e.g., VO₂) within composite coating 212 on an optically-transparent substrate 216 (e.g., silica glass). Less than this phase transition temperature, the nanoparticles 214 can be in an electrically-insulating stage, such that the coating 212 can be substantially transparent to radiation from the sun 202, for example, both visible light 206 (e.g., wavelength range of 400-700 nm, inclusive) and near-infrared (NIR) light 204 (e.g., wavelength range of 780-2500 nm, inclusive). The smart window 210 thus allows more light to enter the building to passively heat the interior 218 during the cold exposure 200, as shown in FIG. 2A.

Conversely, during a hot exposure 220 (e.g., summer season), the ambient temperature in the environment 208 can be higher than the phase transition temperature of nanoparticles 214 within ceramic coating 212, such that the nanoparticles 214 are in a metallic phase. In this metallic phase, the nanoparticles 214 may block (e.g., reflect) at least part of the solar radiation. For example, the nanoparticles 214 may block passage of NIR light 204 into the building interior 218 while still allowing visible light to pass therethrough. The smart window 210 can thus reduce passive heating of the interior 218 by solar radiation (and thereby reduce the amount of cooling required), while otherwise maintaining the ability for one to see through the window.

Unlike thermochromic windows that employ a continuous film of VO₂ (and thus can be susceptible to low visible light transmission, e.g., <50%, and low solar modulation ability, e.g., <10%, the disclosed smart windows with nanoparticles 214 integrated into coating 212 can exhibit high visible light transmission (e.g., at least 60%) and high solar modulation ability (e.g., >10%, such as ˜20%). Moreover, the optical performance of the ceramic coating can be tailored by appropriate selection of VO₂ nanoparticle size, the volume ratio of VO₂ to the transparent ceramics, and/or coating thickness.

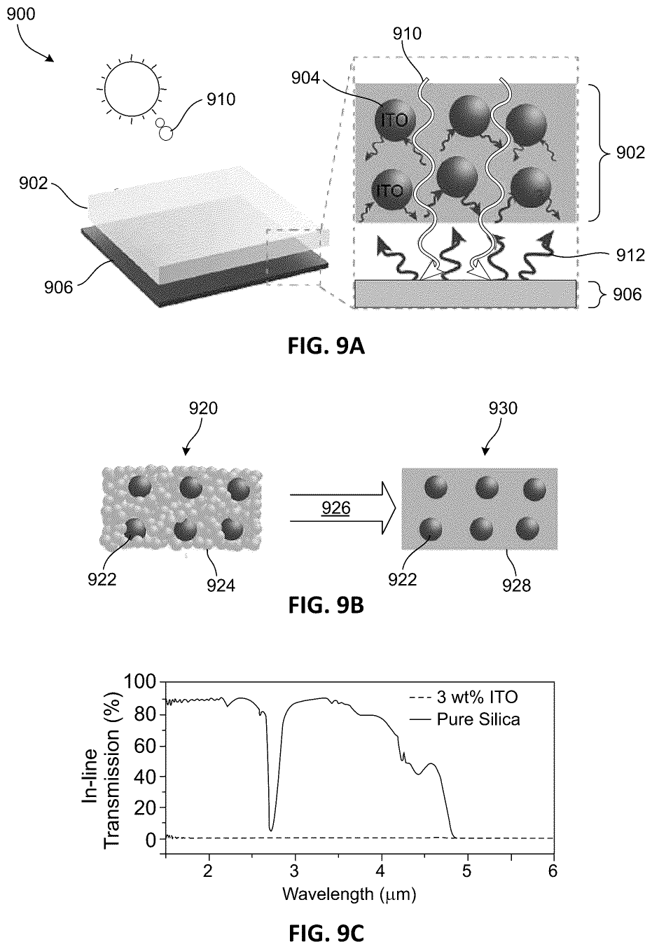

Alternatively or additionally, embodiments of the disclosed subject matter can be extended to fabricating other functional glasses, such as windows for use in industrial, high-temperature applications. For example, conventional commercially-available glass may not be suitable for high-temperature applications because they are transparent to infrared (IR) light (e.g., in a wavelength of 2.5-5 μm). In some embodiments, a transparent glass composite can be used to address this shortcoming, for example, by being substantially transparent with respect to visible light while blocking (e.g., absorbing) IR light. For example, in FIG. 9A, a transparent glass composite 902 is embedded with IR plasmonic nanoparticles 904 (e.g., indium tin oxide, ITO). The IR plasmonic nanoparticles 904 can suppress thermal radiative losses by absorbing and re-emitting IR thermal radiation 912, while allowing visible light 910 to pass therethrough to an underlying structure 906 (e.g., absorber). For example, glass composite 902 can be employed in concentrated solar power plants or observation windows for high-temperature chambers, among other potential applications.

### Fabricated Examples and Experimental Results

### Example 1— Glass

Silica powder with a mean particle size of ˜11 nm was used as a precursor for silica glass manufacturing. The silica powder was shaped into an initial pellet using a pressing mold (e.g., having diameters of 22 or 8 mm). Cold isostatic pressing (CIP) was then applied to the pellet under a pressure of 40 MPa for 40 seconds to achieve a denser structure. The heating element was made of a carbon felt heating strip (AvCarb Felt G200, ˜10 cm in length, ˜2 cm in width, and ˜3 mm in thickness). The center of the carbon felt heating strip was cut to sandwich the sample pellet 410 (e.g., with the pellet in direct contact with the heating element). Opposing ends of the carbon felt were fixed on respective pieces of graphite sheets by clamps. The graphite sheets were respectively connected to outputs of an adjustable switch power supply featuring tunable voltage and current (0-100 V and 0-50 A). The output power of the power supply was adjusted to control the temperature of the carbon heater.

Sintering was performed using the heating element and the CIP precursor pellet in an Ar-filled glovebox. After sintering 412 by exposing to a high-temperature heating pulse from the heating element, the pellet 410 was transformed into a fully transparent and uniform glass 414, as shown in FIG. 4B. After sintering, surfaces of the sintered specimens were carefully polished using abrasive paper (1200 fine grit). As shown in FIG. 4C, the disclosed sintering via high-temperature heating pulse can achieve 1-3 orders of magnitude faster sintering as compared to other techniques, such as gel-casting and sintering, conventional furnace sintering, SPS, laser sintering, and flash sintering (FS).

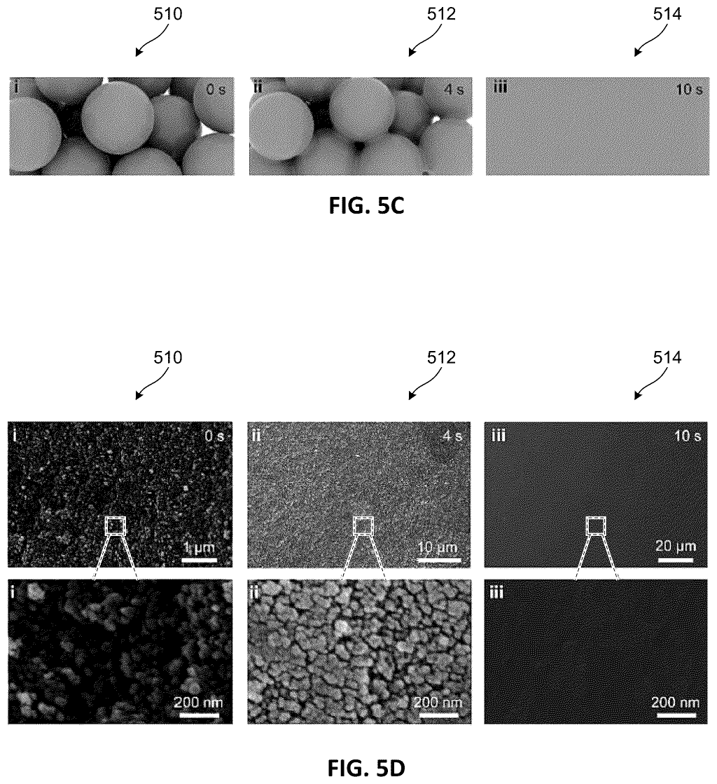

During a ramp-up period 502, the temperature applied to the pressed silica pellet can be gradually increased from room temperature, T₁, (e.g., 293-298 K) to an elevated sintering temperature, T₂, (e.g., ˜1600 K), as shown in FIG. 5A. For example, a duration of the ramp-up period 502 can be less than or equal to about 10 seconds, such that a heating rate of at least 10 K/s (e.g., ˜10² K/s) is achieved. In some embodiments, the pellet can be held isothermally at the sintering temperature, T₂, for a dwell period 504 (e.g., 3-60 seconds, e.g., ˜10 seconds). After the dwell period 504, the pellet can be rapidly cooled down during a ramp-down period 506, from the sintering temperature, T₂, back to room temperature, T₁ (or a temperature close to, but greater than, room temperature). For example, a duration of the ramp-down period 506 can be less than or equal to about 10 seconds, such that a cooling rate of a least 10 K/s (e.g., ˜10² K/s) is achieved. During the dwell period 504, a fast volumetric shrinkage of the precursor pellet was observed, as shown in FIG. 5B. For example, the silica glass shrank 28.7% in diameter (e.g., from 15.25 to 10.87 mm) and 27.9% in thickness (e.g., from 2.01 to 1.45 mm). This isotropic shrinkage can be attributed to the uniform sintering temperature and pressure-less nature of the method.

The sintering temperature can be easily controlled by adjusting the applied power for the carbon heater. The wide temperature range (e.g., 300-3300 K) offered by the Joule heating element can enable application of the disclosed technique to rapid discovery and screening of other advanced glass materials. The schematics of FIG. 5C and the corresponding cross-sectional scanning electron microscopy (SEM) images of FIG. 5D show the evolution of the silica glass microstructure during the different stages 510-514 of dwell period 504. At the beginning 510 of the dwell period 504 (e.g., prior to sintering), the precursor pellet has a low relative density of ˜35% and was translucent due to the uniformly distributed nanopores between the nanoparticles. By an intermediate stage 512 of the dwell period 504 (e.g., after sintering at ˜1600 K for ˜4 seconds), the nanoparticles begin to merge with neighboring nanoparticles, and the nanopores become smaller, decreasing the porosity with the relative density of ˜78%. At the end 514 of the dwell period 504 (e.g., completion of the sintering), a uniform and dense silica glass is achieved without any obvious pores or cracks, and the relative density increased to ˜98.4%, further demonstrating the ability of the disclosed techniques to rapidly sinter dense silica glass.

In addition, X-ray diffraction (XRD) patterns revealed that the sintered silica glass features an amorphous structure. Despite being in contact with the Joule heating element, carbon remnants were not seen on any samples after sintering, since there was no applied mechanical pressure during the high temperature exposure. Additionally, the disclosed sintering techniques can be applied to micropowders (e.g., ˜44 μm) for silica glass fabrication. Using a sintering temperature of ˜1600 K and a sintering time (e.g., dwell period duration) of ˜5 seconds, a glass with a relative density of >98% was produced from a precursor pellet formed of silica micropowders.

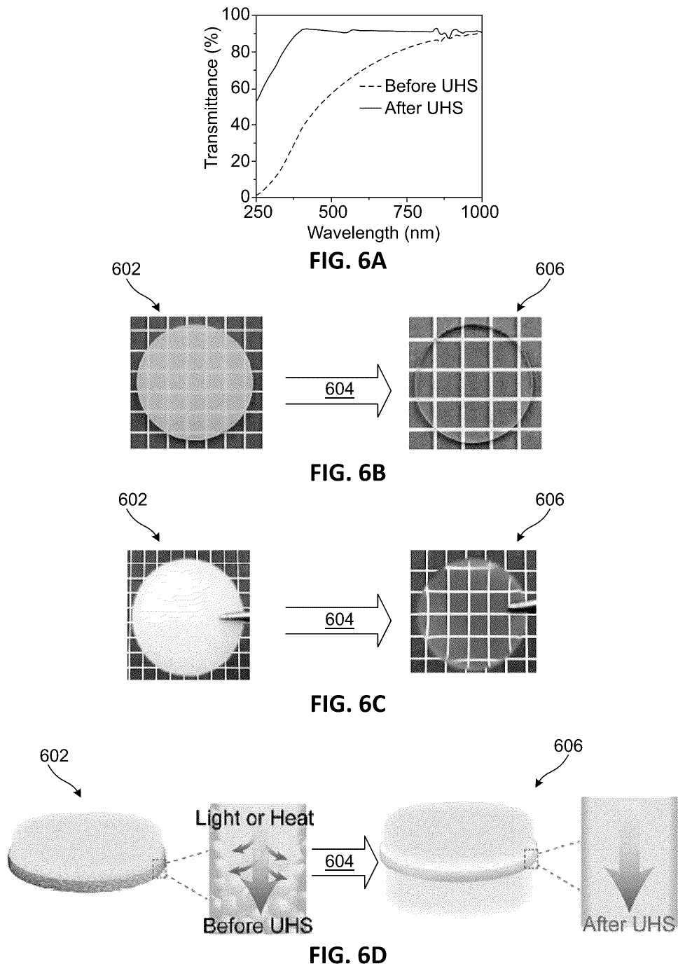

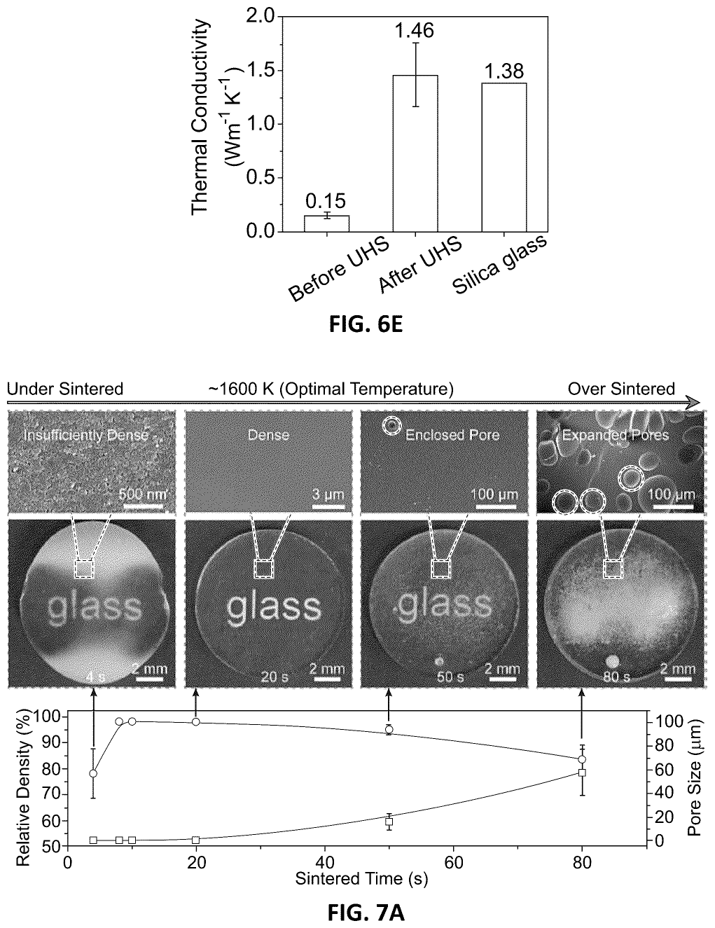

The flexural stress of both a commercial glass slide and sintered glass formed using the disclosed techniques was evaluated via a three-point bending test. The measured flexural stress of the sintered glass was ˜70 MPa, which is comparable with that of commercial float glass (e.g., ˜58 MPa). The results indicate that the fast cooling in the disclosed techniques does not undermine the mechanical properties of the sintered glass. To evaluate the transparency of the silica pellet before and after the sintering process, the transmittance was measured using ultraviolet-visible (UV-Vis) spectroscopy for wavelengths in a range of 250-1000 nm, inclusive. In the 250-350 nm range, the sintered glass exhibited low transmittance due to the absorption of light by silica, which is comparable to the results of both float glass and silica acrogel. However, for the un-sintered pellet, because the size of the silica nanoparticles (e.g., ˜11 nm) and the size of the gaps between neighboring nanoparticles are much smaller than the incident wavelength (250-1000 nm), the scattering of the light passing through the pellet is roughly described by Rayleigh scattering. As such, the transmittance of the pressed pellet before the sintering process increases with increasing wavelength, as shown in FIG. 6A. For example, in the wavelength range of ˜400-1000 nm, the sintered glass shows a higher transmittance (˜90%) than that of an un-sintered pellet with the same thickness of ˜1.3 mm. As shown in FIG. 6B, objects can be clearly viewed through the glass 606 after sintering 604 due to its high optical transmittance.

In FIGS. 6B-6C, grid paper was used as the background for pictures to show the visual difference in transmittance. The grid lines can be seen for both the pressed pellet 602 and sintered glass 606 when they are placed directly against the grid, as shown in FIG. 6B. When the pellets are 3 cm above the grid, as shown in FIG. 6C, no lines can be observed for the pressed pellet 602, confirming that the haze of the pressed pellet is large before the sintering process. However, the lines can still be observed through the sintered glass 606 due to its high transmittance.

As illustrated in FIG. 6D, pores in the pressed pellet 602 before sintering can lead to Rayleigh scattering and contact resistance, which reduces the transmittance and thermal conductivity of the samples. Moreover, the pellet 602 before sintering 604 showed a lower thermal conductivity due to the extended heat transfer path caused by its porous structure and the contact resistances between neighboring silica nanoparticles. In contrast, in the dense silica glass 606 after sintering 604, light and heat can directly transmit through, resulting in a relatively higher transmittance and/or thermal conductivity. For example, the sintered silica glass 606 exhibited a thermal conductivity of ˜1.46 W/(m·K), which is comparable to the value of 1.38 W/(m·K) for silica glass. In contrast, the thermal conductivity of the pressed pellet 602 was only ˜0.15 W/(m·K), which is ˜9 times lower than that of the sintered glass, as shown in FIG. 6E. Such a large difference in transmittance and thermal conductivity resulted from the changes in the glass microstructure after the sintering process.

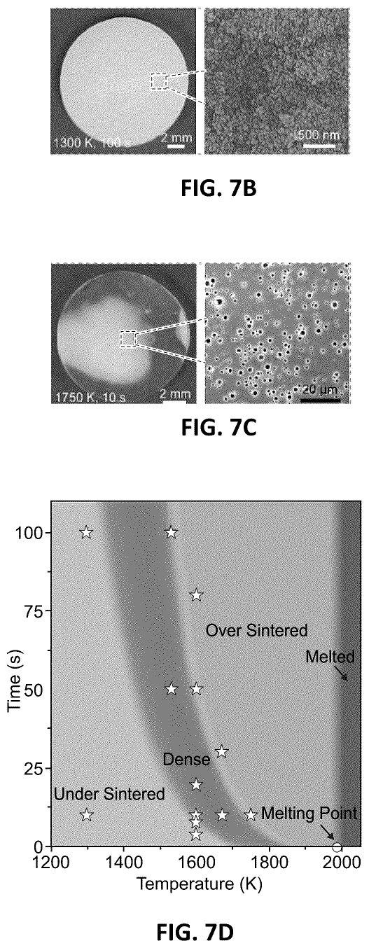

To further explore the sintering mechanism of silica glass in the sintering process, detailed studies with different sintering parameters (e.g., time and temperature) were conducted. All pellets were sintered in an inert argon (Ar) environment. First, pellets were sintered at a constant sintering temperature of ˜1600 K with varying sintering holding times ranging from 4-80 seconds, inclusive, as shown in FIG. 7A. When the sintering holding time was in the range of ˜8-20 seconds, dense silica glasses were sintered with high relative densities of >98%, as shown in FIG. 7A. As the sintering time increased to 50 seconds, the relative density decreased slightly to 95.1%; meanwhile, a small number of enclosed pores became observable via optical and SEM images. When the sintering time further increased (e.g., ˜80 s), the pores expanded to a size of tens of micrometers, leading to a lower relative density of sintered samples. Without being bound by any particular theory, it is believed that argon becomes trapped in the glass before it is fully heated. In other words, the heat transport in SiO₂ bulk is faster than the heat transfer to argon, such that argon is still below the heater temperature before the pores become closed. As the temperature increases from 300 to 1600 K, the softness and fluidity of the silica glass increases, which reduces the interfacial tension between the entrapped gas and soft solid. Due to the high pressure of the trapped gas under a high-temperature environment, the volume of the entrapped gas increases, resulting in a decreased density. The round-like pores can be attributed to the equilibrium of all local surface tensions of bubbles, indicating that the silica is in a highly-viscous glassy state. Thus, in some embodiments, the sintering holding time can be an important parameter that affects the microstructure of the sintered pellet.

The effect of sintering temperature on the resulting glass was also studied. At low temperature (e.g., ˜1300 K), even though the holding time was extended to 100 seconds, the pellet still did not become dense or transparent due to insufficient sintering, leading to a translucent material, as shown in FIG. 7B. At higher temperatures (e.g., ≥1500 K, such as about 1670 K or about 1750 K), enclosed pores were generated due to over-sintering, as shown in FIG. 7C, despite shortened sintering times (e.g., ˜ 10 seconds). It was further found that transparent silica glass could be readily sintered within a relatively wide range of sintering conditions, which were plotted in the time-temperature diagram of FIG. 7D to demonstrate the appropriate conditions for achieving dense silica glasses (e.g., the “dense” band, ˜1600 K for 5-20 seconds in FIG. 7D).

### Example 2—Colored Glass

To verify the feasibility of the disclosed techniques in the application of functional glasses, multiple colored glasses were sintered. Fabricated colored glasses were fabricated with a simple solution-based doping process (e.g., similar to FIG. 8A), followed by the rapid high-temperature heating pulse to sinter the precursor matrix and kinetically trap in the doped elements. For the doping experiments, 0.2 wt % cobalt(II) chloride hexahydrate (CoCl₂·6H₂O), 0.3 wt % iron(III) chloride hexahydrate (FeCl₃·6H₂O), and 0.15 wt % copper(II) chloride (CuCl₂) were dissolved in ethanol. The pressed pellets were doped with these metal salt solutions by one-time soaking and dried in air for ˜10 min, followed by the high-temperature sintering pulse process to sinter the colored glasses.

FIG. 8B shows a pellet 820 soaked with FeCl₃ ethanol solution to form soaked pellet 822, which was subsequently sintered to form colored glass 824. This facile solution-based doping method can be applied to various metal salts to obtain different colored glasses. For example, as shown in FIG. 8C, blue, yellow, and red glasses were sintered via the high temperature heating pulse process (e.g., at ˜1600 K in seconds) by doping with solutions of CoCl₂FeCl₃, and CuCl₂, respectively, prior to the sintering. The blank glass is also shown in FIG. 8C for comparison. Taken together, these results demonstrate the unique capability of the disclosed techniques to sinter modified glasses for additional optical properties with a solution-based doping method.

### Example 3—Vo₂Nanoparticle Composite

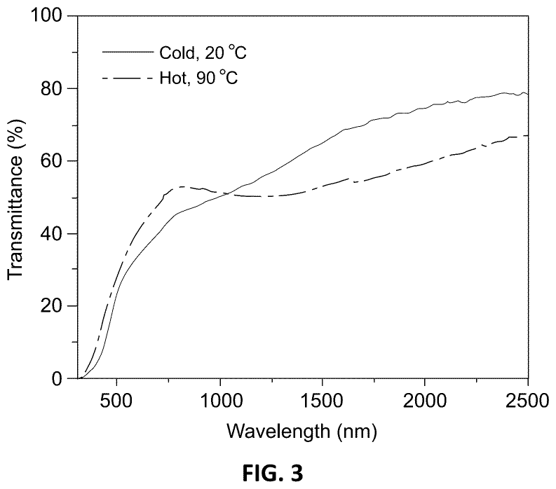

To evaluate the performance of VO₂ nanoparticle-based thermochromic coating on a glass substrate, the total transmittance was measured using a commercial UV-Vis-Near-IR spectrophotometer. The measured total spectral transmittances of the VO₂ nanoparticle-based thermochromic coating on a glass substrate film at low temperature (˜20° C.) and high temperature (˜90° C.) are shown in FIG. 3, in which the size of VO₂ nanoparticles is 50 nm, the film thickness is ˜ 10 μm, and the concentration of VO₂ is 0.01 vol %. The luminous transmittance at low temperature and solar modulation ability are calculated to be ˜ 50% and ˜5%, respectively. Note that the solar modulation ability can be improved by increasing the concentration of VO₂ nanoparticles and/or increasing a thickness of the coating.

### Example 4— Functional Glass Composites

To experimentally demonstrate a transparent glass composite, a precursor 922 of silica powders 924 doped with 3 wt % ITO nanoparticles 922 was sintered via a high-temperature heating pulse 926 (˜1600 K, ˜5 s), as schematically illustrated in FIG. 9B. The sintered functional glass 930 obtained a relative density of >98%, with nanoparticles 922 embedded within the amorphous silica matrix 928. Uniform distribution of the ITO nanoparticles 922 occurred during the sintering process. Unlike sintered pure silica glass, the 3 wt % ITO added glass (with a thickness of ˜1 mm) exhibited a high IR light absorption due to IR plasmon resonances of the internal ITO nanoparticles, as shown in FIG. 9C. Although the fabricated example exhibits a relatively low solar transmittance, the concentration of ITO nanoparticles can be optimized to achieve both high solar transmittance and low IR transmittance (e.g., within the 3-5 μm wavelength range).

The disclosed techniques can also be applied to sinter other glass/amorphous materials and/or transparent ceramics with high quality and fast manufacturing speed. For example, Al₂O₃ (high purity alumina powder CR 10D), Y₂O₃ (99.999%, D50=3-5 μm), and Gd203 (99.9%, average particle size: 20-80 nm) were mixed according to correct stoichiometric ratios. The mixed powder was milled with 0.4 wt % tetraethyl orthosilicate additive for 15 hours. The suspension was then dried at 70° C. for 24 hours. Finally, the powder was sieved with a 200-mesh grid and then was calcined at 1000° C. for 3 hours. Thus, 1% Gd-doped YAG powder was prepared. The silica powder was mixed with proper 1% Gd-doped yttrium aluminum garnet (YAG) powder, ITO powder (<50 nm), or MgO powder (≤ 50 nm) to sinter the silica-based compositions. A transparent 1% Gd-doped YAG powder was sintered with a relative density of ˜90% (e.g., 4.1 g/cm³) via the rapid pressure-less sintering process (e.g., ˜2000 K, ˜30 min, ˜10-4 Torr). Silica-based compositions (e.g., 0.025 wt % ITO, 0.025 wt % MgO, and 0.025 wt % YAG, respectively) with relative densities of >98% (e.g., ˜1600 K, ˜5 s), were also successfully sintered.

### CONCLUSION

Any of the features illustrated or described herein, for example, with respect to FIGS. 1-9C and Examples 1-4, can be combined with any other feature illustrated or described herein, for example, with respect to FIGS. 1-9C and Examples 1-4, to provide systems, devices, structures, materials, methods, and embodiments not otherwise illustrated or specifically described herein. All features described herein are independent of one another and, except where structurally impossible, can be used in combination with any other feature described herein. In view of the many possible embodiments to which the principles of the disclosed technology may be applied, it should be recognized that the illustrated embodiments are only examples and should not be taken as limiting the scope of the disclosed technology. Rather, the scope is defined by the following claims. Applicant therefore claims all that comes within the scope and spirit of these claims.

1. A structure comprising:
a substrate; and
a composite coating formed over a surface of the substrate, the composite coating comprising an oxide matrix and one or more nanoparticles within the oxide matrix,
wherein the one or more nanoparticles comprise a temperature-dependent Mott insulator having a phase transition temperature,
when at a temperature below the phase transition temperature, the composite coating transmits light in a first wavelength range, and
when at a temperature above the phase transition temperature, the composite coating reflects and/or absorbs the light in the first wavelength range.

2. The structure of claim 1, wherein the first wavelength range is 780-2500 nm.

3. The structure of claim 1, wherein the composite coating transmits light in a second wavelength range regardless of a temperature of the composite coating.

4. The structure of claim 3, wherein the second wavelength range is 400-700 nm.

5. The structure of claim 3, wherein:
(a) the substrate is substantially transparent to light in the first and second wavelength ranges;
(b) the oxide matrix is substantially transparent to light in the first and second wavelength ranges; or
(c) both (a) and (b).

6. The structure of claim 1, wherein the one or more nanoparticles are formed of vanadium dioxide (VO₂).

7. The structure of claim 1, wherein the substrate comprises silica glass.

8. The structure of claim 1, wherein the oxide matrix comprises Al₂O₃, B₂O₃, BaO, Bi₂O₃, CaO, H₃BO₃, K₂O, Li₂O, MgO, Na₂CO₃, Na₂O, P₂O₅, PbO, Sb₂O₃, Sb₂O₅, SiO₂, SnF₂, TeO₂, TiO₂, ZnO, or any combination of the foregoing.

9. The structure of claim 1, wherein:
(a) the composite coating has a thickness less than or equal to 50 μm;
(b) the composite coating has a relative density of at least 95%; or
(c) both (a) and (b).

10. The structure of claim 1, wherein a concentration of the one or more nanoparticles in the composite coating is less than or equal to 0.1 wt %.

11. A method comprising:
(i) forming a precursor coating by dispensing a slurry over a surface of a substrate, the slurry comprising a precursor powder and one or more nanoparticles in a solution, the one or more nanoparticles comprising a temperature-dependent Mott insulator having a phase transition temperature; and
(ii) after (i), subjecting the precursor coating to a high temperature heating pulse so as to convert the precursor coating into a composite coating, the high temperature heating pulse comprising exposure to a temperature of at least 1500 K for a duration of less than 60 seconds,
wherein, after (ii), the composite coating has a porosity and/or density greater than the precursor coating,
the composite coating comprises an oxide matrix formed from the precursor powder and the one or more nanoparticles within the oxide matrix,
when at a temperature below the phase transition temperature, the composite coating transmits light in a first wavelength range, and
when at a temperature above the phase transition temperature, the composite coating reflects and/or absorbs the light in the first wavelength range.

12. The method of claim 11, wherein, after (ii), the composite coating transmits light in a second wavelength range regardless of a temperature of the composite coating.

13. The method of claim 12, wherein:
(a) the first wavelength range is 780-2500 nm;
(b) the second wavelength range is 400-700 nm; or
(c) both (a) and (b).

14. The method of claim 12, wherein:
(a) the substrate is substantially transparent to light in the first and second wavelength ranges;
(b) after (ii), the oxide matrix is substantially transparent to light in the first and second wavelength ranges; or
(c) both (a) and (b).

15. The method of claim 11, wherein the one or more nanoparticles are formed of vanadium dioxide (VO₂).

16. The method of claim 11, wherein:
(a) the substrate comprises silica glass;
(b) the precursor powder comprises Al₂O₃, B₂O₃, BaO, Bi₂O₃, CaO, H₃BO₃, K₂O, Li₂O, MgO, Na₂CO₃, Na₂O, P₂O₅, PbO, Sb₂O₃, Sb₂O₅, SiO₂, SnF₂, TeO₂, TiO₂, ZnO, or any combination of the foregoing;
(c) a particle size of the precursor powder is less than or equal to 100 μm; or
(d) any combination of (a)-(c).

17. The method of claim 11, wherein, after (ii):
(a) the composite coating has a thickness less than or equal to 50 μm;
(b) the composite coating has a relative density of at least 95%;
(c) a concentration of the one or more nanoparticles in the composite coating is less than or equal to 0.1 wt %; or
(d) any combination of (a)-(c).

18. The method of claim 11, wherein:
(a) the temperature of the high temperature heating pulse is in a range of 1500-1700 K, inclusive;
(b) the duration of the high temperature heating pulse is in a range of 3-30 seconds, inclusive; or
(c) both (a) and (b).

19. The method of claim 11, wherein the high temperature heating pulse further comprises:
prior to the duration, heating to the temperature at a heating rate of at least 10² K/s; and
after the duration, cooling from the duration at a cooling rate of a least 10²K/s.

20. The method of claim 11, wherein the high temperature heating pulse is generated by passing an electrical current through a Joule heating element spaced from the precursor coating.
